(19) United States
(12) Patent Application Publication
(10) Pub. No.: US 2025/0256508 A1
(43) Pub. Date: Aug. 14, 2025

(54) LIQUID DISCHARGE HEAD AND LIQUID DISCHARGE APPARATUS

(71) Applicants: Yasunori SUGIMOTO, Kanagawa (JP); Shusei MURAI, Tokyo (JP); Shinji AOKI, Kanagawa (JP); Hirofumi KOBAYASHI, Kanagawa (JP)

(72) Inventors: Yasunori SUGIMOTO, Kanagawa (JP); Shusei MURAI, Tokyo (JP); Shinji AOKI, Kanagawa (JP); Hirofumi KOBAYASHI, Kanagawa (JP)

(21) Appl. No.: 19/026,925

(22) Filed: Jan. 17, 2025

(30) Foreign Application Priority Data
Feb. 9, 2024 (JP) 2024-018689

(51) Int. Cl. B41J 2/14

(52) U.S. Cl. CPC B41J 2/14201; B41J 2002/14362

(57) ABSTRACT

A liquid discharge head includes: a nozzle plate having a nozzle from which a liquid is dischargeable in a discharge direction; a valve movable in the discharge direction to open and close the nozzle; a mover to move the valve in the discharge direction between: an open position at which the valve opens the nozzle; and a closed position at which the valve closes the nozzle; a housing to house the valve and the mover, the housing including: a first housing; a second housing coupled to the first housing at a coupling portion between the first housing and the second housing; and a groove on a periphery of the coupling portion of at least one of the first housing or the second housing; and a sealing in the groove to seal a portion between the housing and the valve.

### CROSS-REFERENCE TO RELATED APPLICATIONS

This patent application is based on and claims priority pursuant to 35 U.S.C. § 119 (a) to Japanese Patent Application No. 2024-018689, filed on Feb. 9, 2024, in the Japan Patent Office, the entire disclosure of which is hereby incorporated by reference herein.

### BACKGROUND

### Technical Field

The present embodiment relates to a liquid discharge head and a liquid discharge apparatus.

### Related Art

A liquid discharge head includes a nozzle plate on which a nozzle is formed, a valve that opens and closes the nozzle, a mover that moves the valve between an open position at which the nozzle is opened and a closed position at which the nozzle is closed, a housing including a liquid chamber that stores liquid to be discharged from the nozzle and a mover storage that stores the mover, and a sealing that abuts the housing and the valve and seals between the liquid chamber and the mover storage.

### SUMMARY

In an aspect of the present disclosure, a liquid discharge head is provided that includes: a nozzle plate having a nozzle from which a liquid is dischargeable in a discharge direction; a valve movable in the discharge direction to open and close the nozzle; a mover to move the valve in the discharge direction between: an open position at which the valve opens the nozzle; and a closed position at which the valve closes the nozzle; a housing to house the valve and the mover, the housing including: a first housing; a second housing coupled to the first housing at a coupling portion between the first housing and the second housing; and a groove on a periphery of the coupling portion of at least one of the first housing or the second housing; and a sealing in the groove to seal a portion between the housing and the valve. The groove fixes a position of the sealing in the discharge direction.

### BRIEF DESCRIPTIONS OF DRAWINGS

A more complete appreciation of embodiments of the present disclosure and many of the attendant advantages and features thereof can be readily obtained and understood from the following detailed description with reference to the accompanying drawings, wherein:

FIGS. 1A and 1B are external illustrative views of a liquid ejection head according to an embodiment of the present embodiment;

FIG. 2 is an entire cross-sectional view of the liquid discharge head;

FIG. 3 is a diagram for illustrating an arrangement of a heater provided in a first housing;

FIG. 4 is a schematic configuration diagram illustrating a basic configuration of a liquid discharge module;

FIG. 5 is an enlarged view of the periphery of a valve through hole of the liquid discharge head of a comparative example;

FIG. 6 is an enlarged view of the periphery of a valve through hole of the liquid discharge head of the present embodiment;

FIGS. 7A and 7B are diagrams illustrating a state in which the needle valve is moved from a nozzle closed position to a nozzle open position;

FIGS. 8A and 8B are diagrams for illustrating a parting line of the sealing;

FIG. 9 is a schematic configuration diagram illustrating an example in which a holding groove is a triangular groove;

FIG. 10 is a schematic configuration diagram of a liquid discharge head provided with a liquid discharge module according to a modification;

FIGS. 11A and 11B are schematic diagrams illustrating another modification of a liquid discharge module;

FIG. 12 is a schematic perspective view of a liquid discharge apparatus;

FIG. 13 is a diagram illustrating an example of a supply apparatus that supplies paint to a plurality of liquid discharge heads provided in the liquid discharge apparatus; and

FIG. 14 is a diagram illustrating an example of an electrode manufacturing apparatus.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION OF EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A best mode for carrying out the present embodiment will be hereinafter described with reference to the drawings. It is to be understood that those skilled in the art can easily change and correct the present embodiment within the scope of claims to form other embodiments, and these changes and corrections are included in the scope of claims. The following description is an example of the best mode of the present embodiment, and does not limit the scope of claims.

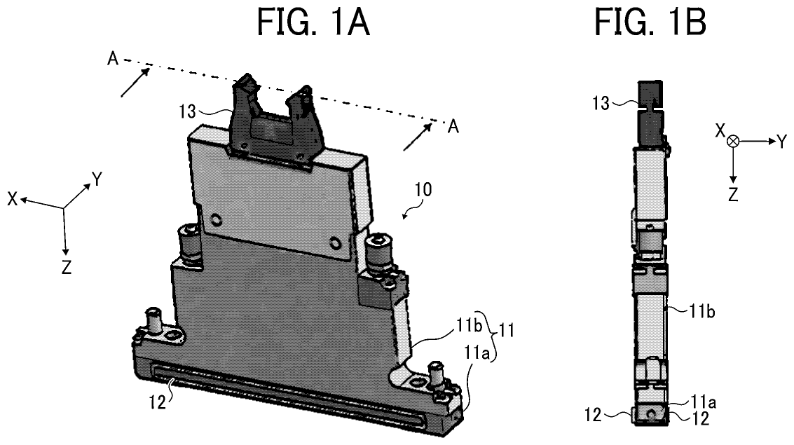

FIGS. 1A and 1B are external illustrative views of a liquid discharge head 10 according to an embodiment of the present embodiment. FIG. 1A is an entire perspective view of the liquid discharge head 10, and FIG. 1B is an entire side view of the head.

In FIGS. 1A and 1B, a longitudinal direction of the liquid discharge head 10 (arrangement direction of nozzles 14) is defined as an X direction, and a lateral direction of the liquid discharge head 10 is defined as a Y direction. A height direction of the liquid discharge head 10 is defined as a Z direction. In the subsequent drawings, the definition of coordinates is similar unless otherwise specified. The height direction is also referred to as “an opening/closing direction of a needle valve 31”, “a moving direction of the needle valve 31”, or “a liquid discharge direction from the nozzle 14”.

The liquid discharge head 10 is provided with a housing 11 as a housing. The housing 11 includes a first housing 11a and a second housing 11b. The second housing 11b is stacked and joined to the first housing 11a. The first housing 11a is made of a material having high thermal conductivity such as metal and having high resistance to liquid such as ink, and the second housing 11b is made of the same material as the first housing 11a. In the present embodiment, the first housing 11a and the second housing 11b are made of stainless steel (SUS). A material not having high thermal conductivity such as resin may be used as long as an apparatus does not heat the liquid using a heater.

The first housing 11a is provided with heaters 12 as heating units on its front and rear surfaces. The heater 12 can control temperature and heats the first housing 11a. The second housing 11b is provided with a connector 13 for communication of electric signals on its upper portion.

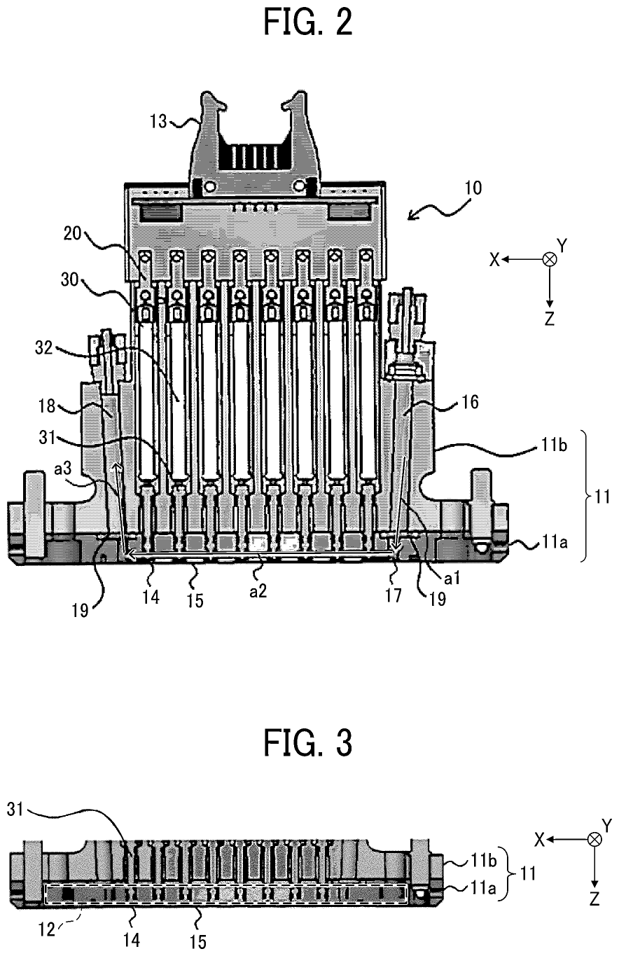

FIG. 2 is an entire cross-sectional view of the liquid discharge head 10, and is a cross-sectional view taken along line A-A of FIG. 1A.

The first housing 11a holds a nozzle plate 15. The nozzle plate 15 is provided with a plurality of nozzles 14 for discharging liquid. The plurality of nozzles 14 is arranged in the longitudinal direction of the liquid discharge head 10 (X direction).

A supply port 16 for supplying liquid such as ink into the head is provided on one end in the X direction of the second housing 11b, and a recovery port 18 for ejecting the liquid from the head is provided on the other end in the X direction.

The first housing 11a is provided with a liquid chamber 17 that stores liquid. The supply port 16 is connected to one end in the X direction of the liquid chamber, and the recovery port 18 is connected to the other end in the X direction of the liquid chamber 17. As indicated by arrow a1 in the drawing, the liquid supplied from the supply port 16 to one end side in the X direction of the liquid chamber moves inside the liquid chamber 17 to the other end side in the X direction as indicated by arrow a2 in the drawing. As indicated by arrow a3 in the drawing, this moves in the recovery port 18 and is ejected from the head.

A plurality of liquid discharge modules 30 is arranged between the supply port 16 and the recovery port 18. The number of the liquid discharge modules 30 corresponds to the number of the nozzles 14, and in this example, a configuration is illustrated in which eight liquid discharge modules 30 corresponding to eight nozzles 14 arranged in one row are provided. The number and arrangement of the nozzles 14 and the liquid discharge modules 30 are not limited to the above description. For example, the number of the nozzles 14 and the number of the liquid discharge modules 30 may be one instead of plural. The number may be eight or larger or smaller. The nozzles 14 and the liquid discharge modules 30 may be arranged in a plurality of rows instead of one row.

Each liquid discharge module 30 is provided with a needle valve 31 as a valve that opens and closes the nozzle 14 and a piezoelectric element 32 as a mover that moves the needle valve 31. The piezoelectric element 32 is connected to a drive controller via the connector 13. When a voltage is applied to the piezoelectric element 32 by the drive controller, the piezoelectric element 32 contracts in the Z direction, the needle valve 31 rises to open the nozzle 14, and liquid is discharged from the nozzle 14. When no voltage is applied to the piezoelectric element 32, the needle valve 31 closes the nozzle 14. In this state, the liquid is not discharged from the nozzle 14. As the mover for moving the needle valve 31, a solenoid may be used.

A regulation member 20 that regulates upward movement of the liquid discharge module 30 is provided on an upper portion of the liquid discharge module 30. A housing seal member 19 is provided in a joint portion between the first housing 11a and the second housing 11b of the supply port 16 and a joint portion between the first housing 11a and the second housing 11b of the recovery port 18. In this example, an O-ring is used as the housing seal member, and the O-ring prevents leakage of liquid from the joint portion between the first housing 11a and the second housing 11b.

FIG. 3 is a diagram for illustrating the arrangement of the heater 12 provided in the first housing 11a. As indicated by a broken line in FIG. 3, the heaters 12 provided on the front and rear surfaces of the first housing 11a are provided in the vicinity of the nozzles 14 so as to cross the plurality of nozzles 14.

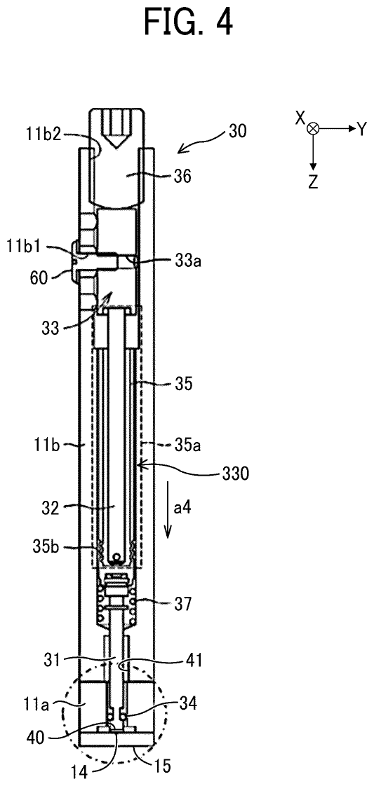

FIG. 4 is a schematic configuration diagram illustrating a basic configuration of the liquid discharge module 30.

In addition to the needle valve 31 and the piezoelectric element 32 described above, the liquid discharge module 30 is mainly provided with a securing member 33, a holder 35, and a plug 36. The holder 35 includes a drive body storage unit 35a therein, and stores and holds the piezoelectric element 32 in the drive body storage unit 35a. The holder 35 is made of metal such as stainless steel such as SUS304 or SUS316L. The holder 35 is a frame body in which a plurality of elongated members extending in the longitudinal direction is arranged around the piezoelectric element 32 (for example, four elongated members are arranged at 90° intervals), and the piezoelectric element 32 is inserted into the holder 35 through between the elongated members forming the holder 35.

The needle valve 31 is coupled to a leading end portion on the nozzle 14 side of the holder 35. A bellows portion 35b is formed on the nozzle 14 side of the holder 35, and is elastically expandable/contractable in the longitudinal direction of the piezoelectric element 32. The bellows portion 35b is used to expand and contract the leading end portion on the nozzle side of the holder 35 in the Z direction in the same manner as the piezoelectric element 32 when the piezoelectric element 32 expands and contracts.

The securing member 33 is coupled to a proximal end side on an opposite side of the nozzle 14 side of the holder 35. In other words, the securing member 33 is stored in an upper end portion of the second housing 11b. The securing member 33 includes a through screw hole 33a extending in a radial direction. A positioning screw 60 is screwed into the through screw hole 33a from the outside of the second housing 11b.

The positioning screw 60 is inserted into an elongated hole 11b1 in the longitudinal direction in the upper end portion of the second housing 11b. Therefore, the positioning screw 60 is movable by a predetermined length in the Z direction. The positioning screw 60 is fastened in a state in which the securing member 33 positioned in the Z direction.

A female screw hole 11b2 is formed in an upper end opening of the second housing 11b. The plug 36 abutting the regulation member 20 of FIG. 2 is screwed into the female screw hole 11b2. The plug 36 abuts an upper end portion of the securing member 33 positioned in the longitudinal direction by the positioning screw 60 to finally secure the position of the securing member 33.

A compression spring 37 is arranged in a lower end portion of the second housing 11b. The compression spring 37 biases the piezoelectric element 32 and the holder 35 that holds the piezoelectric element 32 upward.

The needle valve 31 is formed of a metal material such as stainless steel (SUS), and an elastic member 40 such as rubber is provided in a leading end portion on the nozzle 14 side of the needle valve 31. When the elastic member 40 of the needle valve 31 is pressed against the nozzle plate 15, the elastic member 40 is compressed, so that the nozzle 14 is surely closed by the needle valve 31.

The first housing 11a is provided with a valve through hole 41 through which the needle valve 31 penetrates. In the valve through hole 41, an annular sealing 34 such as an O-ring is provided to seal such that the liquid in the liquid chamber 17 does not leak, and prevent liquid from entering a piezoelectric element storage unit 330.

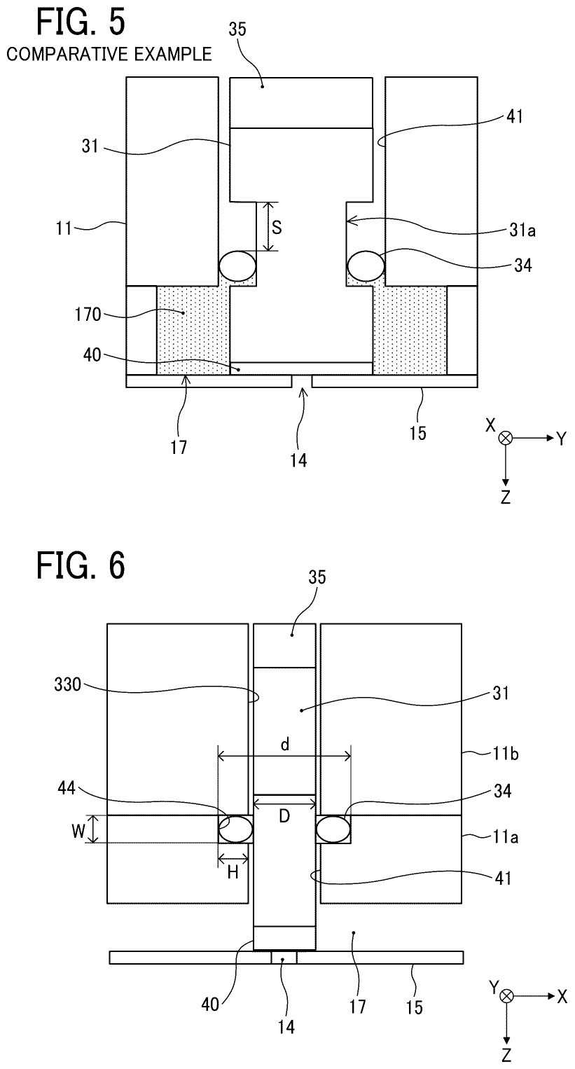

FIG. 5 is an enlarged view of the periphery of the valve through hole 41 of the liquid discharge head of a comparative example.

As illustrated in FIG. 5, in the liquid discharge head of the comparative example, the needle valve 31 is provided with an annular holding groove 31a that holds the annular sealing 34. A groove width (Z-direction length) of the holding groove 31a is wider than a wire diameter (thickness) of the sealing 34, and the sealing 34 was held so as to be movable in the holding groove 31a by a predetermined range in the Z direction.

Therefore, due to a difference between sliding resistance between the sealing 34 and an inner peripheral surface of the valve through hole 41 and sliding resistance between the sealing 34 and a bottom surface of the holding groove 31a, the sealing 34 moves in the Z direction together with the needle valve 31 and slides on the inner peripheral surface of the valve through hole 41, or remains on the spot and slides on the bottom surface of the groove portion during an opening/closing operation of the needle valve 31. In a case where the sliding resistance in a circumferential direction is not constant, the sealing 34 might be inclined or twisted with respect to the Y direction in the drawing. As a result, a movement resistance during the opening/closing operation of the needle valve 31 varies between the liquid discharge modules 30, and a movement amount and a moving speed of the needle valve 31 vary. The variation in the movement amount of the needle valve 31 affects a variation in distance between the nozzle 14 and the needle valve 31 when the nozzle 14 is opened, and the variation results in a variation in fluid resistance when the liquid in the liquid chamber 17 flows to the nozzle 14. Such variation results in a variation in discharge speed and discharge amount per unit time of the liquid discharged from the nozzle 14. The variation in the moving speed of the needle valve 31 affects a variation in time in which the needle valve 31 is opened, and thus affects a variation in size of a discharge droplet when the opening/closing operation is performed at a high frequency. As a result, there has been a possibility that a discharging performance varies among the nozzles.

Therefore, in the present embodiment, the sealing 34 is held so as not to be movable in the moving direction of the needle valve 31 (Z direction). Hereinafter, features of the present embodiment are described with reference to the drawings.

FIG. 6 is an enlarged view of the periphery of the valve through hole 41 of the liquid discharge head 10 of the present embodiment.

As illustrated in FIG. 6, in the present embodiment, an upper end of the valve through hole 41 of the first housing 11a is cut out, and the second housing 11b and the first housing 11a form an annular holding groove 44 that holds the annular sealing 34. A groove width W (Z-direction length) of the holding groove 44 is narrower than a Z-direction length in an uncompressed state of the sealing 34. Therefore, the sealing 34 of the holding groove 44 is interposed and held between the first housing 11a and the second housing 11b in the Z direction, which is the moving direction of the needle valve 31. Accordingly, the sealing 34 is held in the holding groove 44 so as not to be movable in the Z direction. Thus, the first housing 11a and the second housing 11b can fix the position of the sealing 34 in the Z direction.

In the present embodiment, it is sufficient that the sealing 34 abuts an outer peripheral surface of the needle valve 31 and the holding groove 44 at a predetermined abutting pressure to seal such that the liquid in the liquid chamber 17 does not leak, and an O-ring, a D-ring, an X-ring, and a T-ring can be applied. The O-ring has a circular or elliptical cross-sectional shape in the cross section of FIG. 6, the D-ring has a cross-sectional shape similar to an alphabet “D” obtained by cutting out a part of the circular shape with a straight line, and the X-ring and the T-ring have shapes in which grooves and ribs are provided so as to have cross-sectional shapes similar to “X” and “T”. In the present embodiment, the sealing 34 having an intermediate shape between the O-ring and the D-ring is used.

As a material of the sealing 34, an elastic member such as rubber, resin, or elastomer is preferable, and other materials may be adopted as long as the ink can be sealed. The material of the sealing 34 is necessary to have characteristics such as chemical resistance and solvent resistance, and examples of the material of the sealing include, for example, perfluoroelastomer (4275B, manufactured by MORISEI KAKO Co., Ltd.).

The Z direction (needle valve moving direction) length (thickness in the Z direction) of the sealing 34 is preferably 1 mm or more. The sealing 34 has an inner diameter of at least 1 mm and an outer diameter of about 3 mm.

Sealing between the sealing 34 and the housing 11 is performed by interposing between the first housing 11a and the second housing 11b. Specifically, the groove width W of the holding groove 44 is made shorter than the thickness in the Z direction of the sealing 34 (in the uncompressed state) so that a crushing ratio in the Z direction of the sealing 34 becomes 15±10%. When the crushing ratio is less than 5%, sealing with the housing is insufficient, and leakage might occur due to a liquid pressure in the liquid chamber. In contrast, when the crushing ratio exceeds 25%, permanent distortion of the sealing might occur.

When the thickness in the Z direction of the sealing 34 in the uncompressed state is W0 and the thickness in the Z direction in a compressed state, that is, a crushed state is W, the crushing ratio can be obtained by (W0−W)/W0×100(%).

In such a configuration, it is preferable that an inner diameter d of a bottom surface of the annular holding groove 44≥the outer diameter of the sealing 34 in the uncompressed state. As a result, it is not necessary to reduce the diameter of the sealing 34 to assemble to the holding groove 44, and the sealing 34 can be easily assembled to the holding groove 44.

By making an outer diameter D of the sliding portion of the needle valve 31 with the sealing 34 larger than the inner diameter of the sealing 34 in the uncompressed state to expand the sealing 34 in diameter (the inner diameter of the sealing in an unexpanded state<the outer diameter D of the sliding portion of the needle valve 31), the sealing between the sealing 34 and the needle valve 31 is performed. An optimum range of an elongation ratio of the sealing 34 at that time can be set according to the material and shape of the sealing 34. For example, by setting the elongation ratio of the sealing to ½ or less of the elongation ratio at break, it is possible to satisfactorily seal the sliding portion between the sealing 34 and the needle valve 31. It is further preferable that the elongation ratio of the sealing 34 is 5% or more and 25% or less. By setting the elongation ratio of the sealing 34 to 5% or more and 25% or less, it is possible to reduce the sliding resistance between the sealing 34 and the needle valve 31 and seal such that the liquid does not leak to the drive body storage unit 35a due to the pressure applied to the liquid in the liquid chamber 17.

When an inner diameter of the sealing in the unexpanded state of the sealing 34 is set to D0 and an inner diameter in an expanded state of the sealing 34 is set to D1, the elongation ratio can be obtained by (D1−D0)/D0×100(%). The inner diameter D1 in the expanded state of the sealing 34 is equal to the outer diameter D of the sliding portion of the needle valve 31. Therefore, the elongation ratio may be obtained by (D-D0)/D1×100(%).

The inner diameter of the sealing 34 may be reduced by crushing of the sealing 34 due to compression of the sealing 34 in the Z direction by the first housing 11a and the second housing 11b, so that the sealing 34 can contact the needle valve 31 to perform sealing with the needle valve 31. In such a configuration, the inner diameter of the sealing in the uncompressed state>the outer diameter D of the needle valve can be satisfied, and an assembly work of the sealing 34 and the needle valve 31 can be facilitated.

As the sealing 34, it is preferable to use a member a surface of which is coated with a low friction material such as fluorine or silicone and is subjected to a low friction treatment. Here, the low friction material is a material that reduces frictional resistance of the member before coating. Examples of the sealing the surface of which is coated with the low friction material include an SP-treated O-ring (NOK CORPORATION). By using the sealing 34 the surface of which is coated with the low friction material and subjected to a surface low friction treatment, sliding resistance with the needle valve 31 can be reduced. The needle valve 31 can be easily inserted into the sealing 34, and the assembly work of the sealing 34 and the needle valve 31 can be facilitated.

A contact portion of the needle valve 31 with the sealing 34 may be coated with the low friction material such as fluorine or silicone to reduce friction. Examples of a coating material for coating the contact portion of the needle valve with the sealing 34 include BICOAT® (YOSHIDA SKT CO., LTD.). In this manner, by applying the low friction treatment to the contact portion of the needle valve 31 with the sealing 34, the sliding resistance with the sealing 34 can be reduced. The needle valve 31 can be easily inserted into the sealing 34, and the assembly work of the sealing 34 and the needle valve 31 can be facilitated.

The contact portion of the needle valve 31 with the sealing 34 may be set to have arithmetic average roughness Ra of 0.1 μm or less by mirror polishing to reduce friction. It is preferable that the arithmetic average roughness Ra is set to 0.1 μm or less by mirror polishing, and then surface treatment for reducing friction such as diamond-like carbon (DLC) coating is further performed, because sliding resistance with the sealing can be made smaller. The arithmetic average roughness Ra of the contact portion of the needle valve 31 with the sealing 34 may be set to 0.1 μm or less by surface coating.

The above-described low friction treatment may be applied to a surface of one of the sealing 34 and the needle valve 31, or the above-described low friction treatment may be applied to both the sealing 34 and the needle valve 31. Such low friction treatment can reduce sliding resistance generated between the needle valve 31 and the sealing 34 when the needle valve 31 moves. By reducing an absolute value of the sliding resistance, a variation in sliding resistance itself can be reduced. This can reduce a variation in liquid discharging performance.

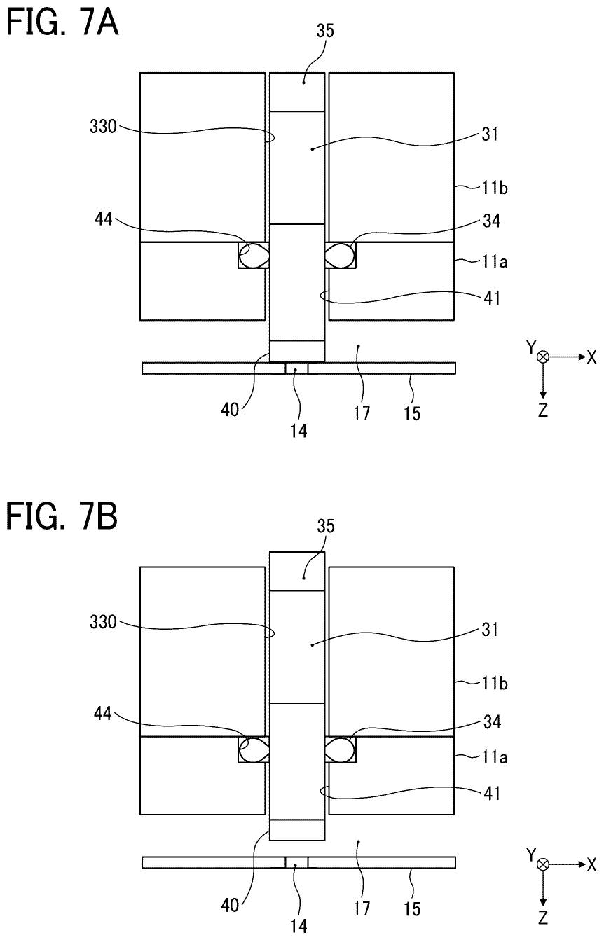

FIGS. 7A and 7B are diagrams illustrating a state in which the needle valve 31 is moved from a nozzle closed position to a nozzle open position, in which FIG. 7A illustrates a state in which the needle valve 31 is located at the nozzle closed position, and FIG. 7B illustrates a state in which the needle valve 31 is located at the nozzle open position.

In the present embodiment, the sealing 34 is interposed between side surfaces of the holding groove 44, and the sealing 34 is held in the holding groove 44 so as not to be movable in the Z direction, which is the moving direction of the needle valve 31. As a result, the sealing 34 slides only on the outer peripheral surface of the needle valve 31 when the needle valve 31 moves. Therefore, the sealing 34 does not slide on an inner wall of the valve through hole 41 in the Z direction. Therefore, in all the liquid discharge modules 30, the sealing 34 slides only on the needle valve 31, and a variation in movement resistance during the opening/closing operation of the needle valve 31 between the liquid discharge modules 30 is suppressed. As a result, a variation in the movement amount and the moving speed of the needle valve 31 can be suppressed, and a variation in discharging performance among the nozzles can also be suppressed.

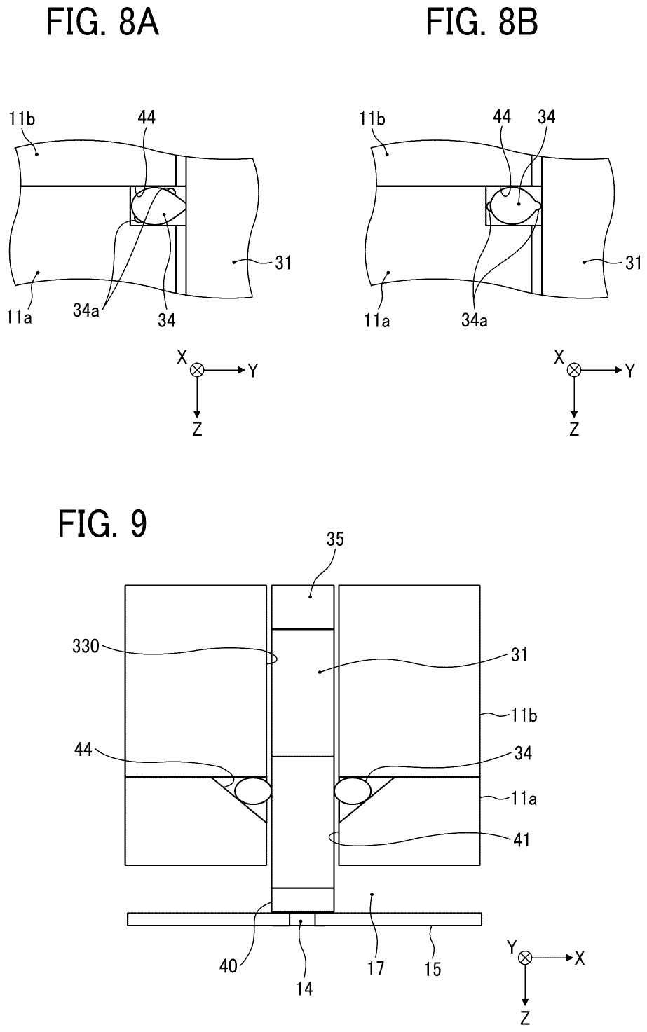

FIGS. 8A and 8B are diagrams for illustrating a parting line 34a of the sealing 34, in which FIG. 8A illustrates the parting line 34a of the sealing 34 of the present embodiment, and FIG. 8B illustrates the parting line 34a of the sealing 34 of the comparative example.

The parting line 34a of the sealing 34 is a protruding portion (also referred to as a burr line) formed when a burr is removed after molding.

As illustrated in FIG. 8B, the parting line 34a of the sealing 34 is generally formed at the center in a central axis direction of the annular sealing 34 (Z direction in the drawing). However, in such a configuration, a portion of the parting line 34a of the sealing 34 abuts the outer peripheral surface of the needle valve 31. Since a height of the parting line 34a is non-uniform, in a case where the parting line 34a abuts the needle valve 31, the abutting pressure between the needle valve 31 and the sealing 34 becomes non-uniform in the circumferential direction, and leakage might occur locally.

In contrast, in the present embodiment, as illustrated in FIG. 8A, a structure of a molding die is devised so that the parting line 34a is formed at a position not in contact with the side surface (the surface orthogonal to the Z direction) of the holding groove 44 and the needle valve 31 that perform sealing with the housing. As a result, it is possible to suppress the abutting pressure between the needle valve 31 and the sealing 34 from becoming non-uniform in the circumferential direction and the abutting pressure with the side surface of the holding groove 44 from becoming non-uniform in the circumferential direction, and it is possible to suppress the occurrence of local leakage.

In the present embodiment, the parting line 34a of the sealing 34 is not in contact with the housing 11 and the needle valve 31, but the parting line 34a may be lightly brought into contact as long as the abutting pressure in the sealing portion is not affected. In other words, the parting line 34a may contact the needle valve 31 or the housing 11 at an abutting pressure sufficiently lower than the abutting pressure in the sealing portion.

FIG. 9 is a schematic configuration diagram illustrating an example in which the holding groove 44 is a triangular groove.

As illustrated in FIG. 9, by forming the holding groove 44 into the triangular groove, crushing of the sealing 34 outward due to compression in the Z direction by the first housing 11a and the second housing 11b (crushing in a direction away from the needle valve 31) is suppressed. As a result, the sealing 34 is crushed in a direction in which the inner diameter further decreases, the abutting pressure of the sealing 34 with the needle valve 31 can be increased, and the sealing with the needle valve 31 can be performed more reliably. Here, the triangular groove is a groove including no bottom surface and having a shape in which at least one of two side surfaces (wall surfaces orthogonal to the Z direction) of the holding groove 44 with which the sealing 34 is in contact is inclined (inclined such that a position in the Z direction of one end of the side surface and a position in the Z direction of the other end are different from each other) in the moving direction (Z direction) of the needle valve 31. The two side surfaces of the holding groove 44 may be inclined, or either one may be inclined. It is not limited to the triangular groove, and a shape in which at least one side surface of the two side surfaces is inclined in the Z direction such that the groove width W (distance between side surfaces) of the holding groove 44 is gradually narrowed with an increasing distance from the needle valve 31 is sufficient, and for example, the groove with a trapezoidal cross-sectional shape parallel to the Z direction may also be used.

The holding groove 44 may be provided in any one of the first housing 11a and the second housing 11b, but the holding groove 44 is preferably formed of the first housing 11a and the second housing 11b. By forming the holding groove 44 of the first housing 11a and the second housing 11b, sealing between the first housing 11a and the second housing 11b can also be performed by the sealing 34. After the sealing 34 is assembled to the cutout formed in one of the first housing 11a and the second housing 11b, the second housing 11b is assembled to the first housing 11a, and the sealing 34 can be compressed in the Z direction. As a result, it is not necessary to press the sealing 34 into the holding groove 44 to assemble, and the sealing 34 can be easily assembled.

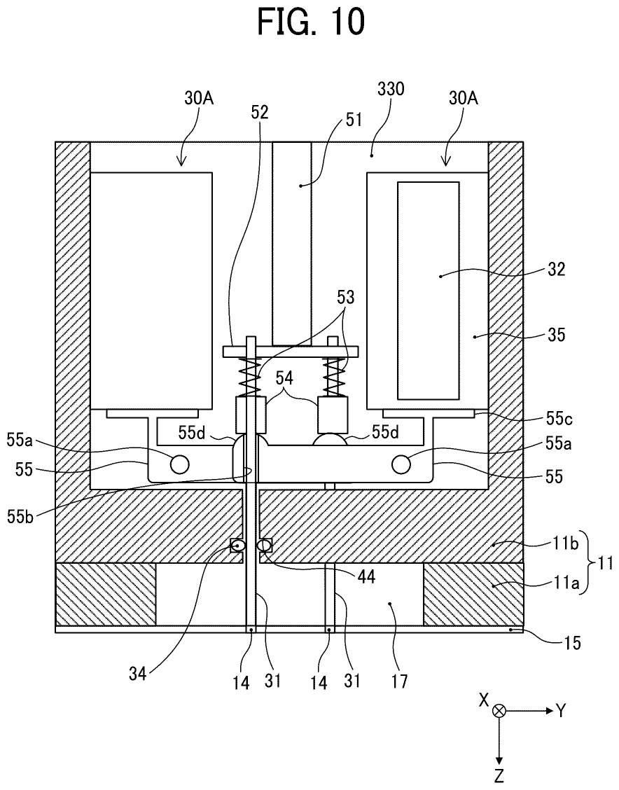

FIG. 10 is a schematic configuration diagram of a liquid discharge head provided with a liquid discharge module 30A according to a modification.

As illustrated in FIG. 10, the liquid discharge module 30A of this modification includes an arm member 55, and by amplifying a displacement amount of the piezoelectric element 32 with the arm member 55, the movement amount of the needle valve 31 is increased.

A plurality of liquid discharge modules 30A is alternately arranged in the X direction such that the needle valve 31 sides face each other in two rows in the piezoelectric element storage unit 330 of the second housing 11b. The plurality of liquid discharge modules 30 is arranged such that a part of the arm member 55 overlaps as seen in the X direction.

Here, the alternate arrangement of the liquid discharge modules 30 can be rephrased as a state in which the liquid discharge module in which an actuator 2 is located on one side of the nozzle arrangement and the liquid discharge module in which the actuator 2 is located on the other side of the nozzle arrangement are arranged to face each other, and are arranged in a nozzle arrangement direction (X direction) such that a part of the arm member 3 overlaps each other as seen in the nozzle arrangement direction (X direction).

The arm member 55 is rotatably supported by a support shaft 55a, and includes one end bonded and secured to the holder 35 that holds the piezoelectric element 32 and the other end in contact with an arm receiver 54 secured to the needle valve 31. A contact portion 55d in contact with the arm receiver 54 on the other end of the arm member 55 has a hemispherical shape protruding toward the arm receiver 54 or a half-moon shape as seen in the X direction, and is smoothly in contact with the arm receiver 54 when the arm member 55 rotates.

On the other end of the arm member 55, a clearance hole 55b through which the needle valve 31 penetrates is formed. An inner diameter of the clearance hole 55b is larger than the outer diameter of the needle valve 31 so that the needle valve 31 does not contact the arm member 55 when the arm member 55 rotates.

An end portion on a side opposite to the nozzle plate side of the needle valve 31 penetrates a spring receiving plate 52. Between the arm receiver 54 secured to the needle valve 31 and the spring receiving plate 52, a compression spring 53 as a biasing unit is provided and biases the needle valve 31 toward the nozzle plate 15 via the arm receiver 54.

By biasing the needle valve 31 toward the nozzle plate 15 by the compression spring 53, the movement of the needle valve 31 between the open position at which the nozzle 14 is opened and the closed position at which the nozzle 14 is closed can be stabilized. The spring receiving plate 52 is attached to a securing member 51 secured to the second housing 11b.

By including the arm member 55, the piezoelectric element 32, which is the largest component among components forming the liquid discharge module 30A, can be arranged on the end side in the Y direction in the piezoelectric element storage unit 330. As a result, the securing member 51 can be arranged at the center in the Y direction in the piezoelectric element storage unit 330, and the spring receiving plate 52 can be secured by one securing member 51. As a result, the liquid discharge head 10 can be downsized.

In this modification, the liquid discharge modules 30A are alternately arranged in the X direction such that a part of the arm member 55 overlaps as seen in the X direction. As a result, the liquid discharge head can be downsized in the Y direction as compared with a configuration in which the arm members do not overlap.

When a securing unit 55c is displaced in the Z direction together with the piezoelectric element 32 by the displacement of the piezoelectric element 32, the arm member 55 rotates about the support shaft 55a as a fulcrum. When the arm member 55 rotates by the displacement of the piezoelectric element 32, the contact portion 55d of the arm member 3 raises the arm receiver 54 against a biasing force of the compression spring 53. As a result, the needle valve 31 rises together with the arm receiver 54, the nozzle 14 is opened, and a droplet is discharged from the nozzle 14 by the pressure applied to the liquid in the liquid chamber 17.

Before the arm member 55 rotates, the top of the contact portion 55d is in contact with the arm receiver 54; however, when the arm member 55 rotates due to the displacement of the piezoelectric element 32, a contact position of the contact portion 55d with the arm receiver 54 shifts to a left side (the other end side of the arm member) in FIG. 10. As described above, since a contact surface of the contact portion 55d with the arm receiver 54 has a circular arc shape as seen in the X direction, the contact position of the contact portion 55d with the arm receiver 54 can be smoothly shifted. As a result, the arm member 55 can be smoothly rotated, and the needle valve 31 can be stably displaced. Therefore, a variation in droplets can be suppressed.

The support shaft 55a that supports the arm member 55 is provided closer to the securing unit 55c than the center of the arm member 55 in the longitudinal direction (Y direction). As a result, a turning radius of the contact portion 55d becomes longer than a turning radius of the securing unit 55c, and a displacement amount of the contact portion 55d in the Z direction becomes larger than a displacement amount of the securing unit 55c in the Z direction. As a result, the displacement amount by which the contact portion 55d raises the arm receiver 54 becomes larger than the displacement amount of the piezoelectric element 32 in the Z direction. As a result, the displacement amount of the piezoelectric element 32 is amplified by the arm member 55, and the movement amount of the needle valve 31 can be increased. Therefore, a gap between the nozzle 14 and the leading end of the needle valve 31 when the needle valve 31 is at the open position can be increased, the liquid easily flows into the nozzle 14, and a size of the droplet discharged from the nozzle 14 can be increased. Therefore, printing efficiency can be enhanced, and a printing time can be shortened. The piezoelectric element 32 having a small displacement amount can be used, the piezoelectric element 32 can be downsized, and the liquid discharge head 10 can be effectively downsized.

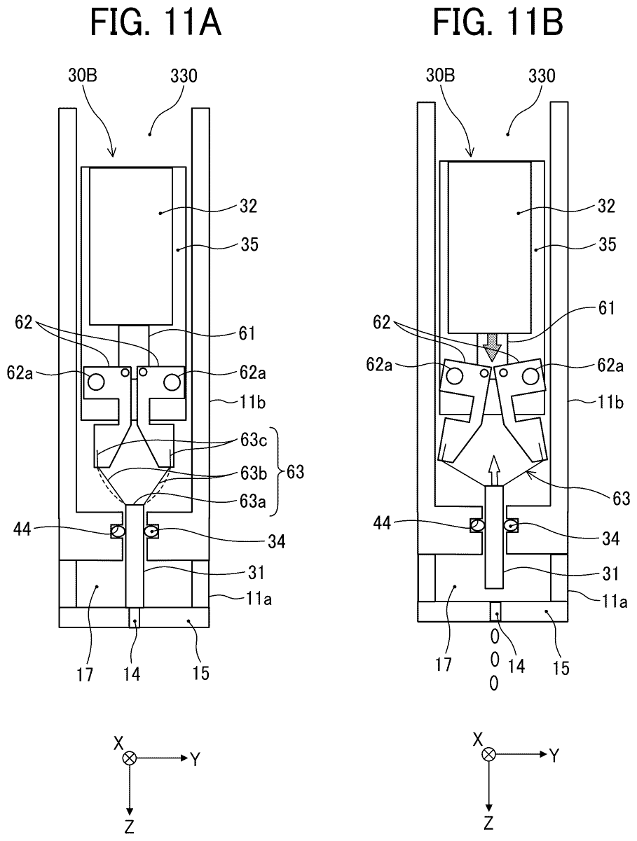

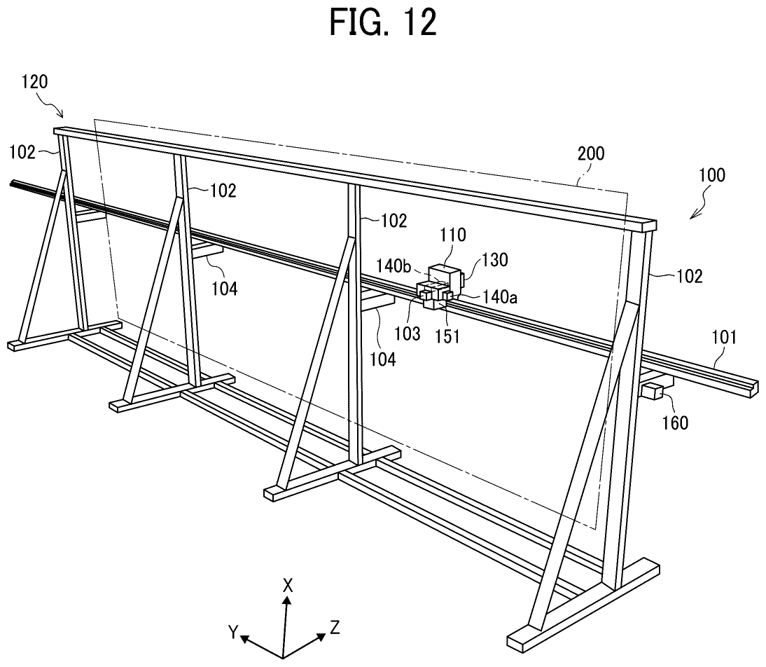

FIGS. 11A and 11B are schematic diagrams illustrating another modification of a liquid discharge module. FIG. 11A is a schematic configuration diagram illustrating a state in which a needle valve 31 closes a nozzle 14, and FIG. 11B is a schematic configuration diagram illustrating a state in which the needle valve 31 opens the nozzle 14.

A liquid discharge module 30B illustrated in FIGS. 11A and 11B includes the needle valve 31, a piezoelectric element 32, a moving member 61, a pair of arm members 62, and a leaf spring member 63. The moving member 61 includes one end secured to the piezoelectric element 32 and the other end to which the pair of arm members 62 is rotatably attached, and is attached to a holder 35 that holds the piezoelectric element 32 so as to be movable in a Z direction. The pair of arm members 62 is rotatably supported by a support shaft 62a attached to the holder 35.

By bending a sheet metal made of stainless steel (SUS), the leaf spring member 63 forms a valve connection portion 63a connected to the needle valve, a pair of inclined portions 63b as elastic deformation portions, and a pair of arm connection portions 63c. The needle valve 31 is joined to the valve connection portion 63a with an adhesive, and the inclined portions 63b extend obliquely upward in the drawing from both ends of the valve connection portion 63a. The arm connection portion 63c is fitted into a slit portion provided on the arm member 62 and attached to the arm member 62.

As illustrated in FIG. 11A, when the needle valve 31 closes the nozzle 14 (a state in which the needle valve 31 is at the closed position), the pair of inclined portions 63b of the leaf spring member 63 elastically deforms as indicated by a broken line in the drawing. As a result, a biasing force that presses the needle valve 31 against the nozzle plate 15 is generated.

As indicated by a black arrow in FIG. 11B, when the piezoelectric element 32 is displaced toward the nozzle 14, the moving member 61 moves toward the nozzle and pushes the pair of arm members 62 toward the nozzle. As a result, the pair of arm members 62 rotates about the support shaft 62a as a fulcrum. When the pair of arm members 62 rotates, both ends of the leaf spring member 63 move in a direction separating from each other. As a result, the needle valve 31 is raised to open the nozzle 14, and the liquid is discharged from the nozzle 14 (corresponding to a state in which the needle valve 31 is at the open position to open the nozzle 14).

The liquid discharge head 10 described above is of a valve jet type, and can discharge a highly viscous liquid or a large droplet (having a diameter of several tens to several hundreds μm) toward a discharge target at a distance (several tens mm ahead). The nozzle diameter can be increased, and liquid containing a material having a large particle diameter can be satisfactorily discharged. In this manner, since liquid having high viscosity can be discharged, the liquid discharge head 10 described above is suitable for painting a vehicle body of a vehicle or a truck, a body of an aircraft, a wall surface of a building, and a road surface, and printing an image. This can also be suitably used for forming an electrode of a lithium ion battery mounted on a vehicle body.

An example of a liquid discharge apparatus including the above-described liquid discharge head 10 will be next described.

FIG. 12 is a schematic perspective view of a liquid discharge apparatus 100.

The liquid discharge apparatus 100 includes a movable frame unit 120 installed to face a liquid discharge target 200.

The frame unit 120 is provided with a Y-axis rail 101 extending in a horizontal direction, a plurality of X-axis rails 102 extending in a vertical direction and provided at predetermined intervals, and a Z-axis rail 103 intersecting the X-axis rails 102 and the Y-axis rail 101.

Each X-axis rail 102 holds the Y-axis rail 101 such that the Y-axis rail 101 extending horizontally is movable in the X direction (the nozzle arrangement direction of the liquid discharge head and the vertical direction). The Y-axis rail 101 holds the Z-axis rail 103 so that the Z-axis rail 103 is movable in the Y-axis direction. The Z-axis rail 103 holds a carriage 110 such that the carriage 110 is movable in the Z direction.

The carriage 110 is provided with a head holder 130. The head holder 130 holds, for example, liquid discharge heads of different colors. For example, a C color liquid discharge head that discharges a cyan paint, an M color liquid discharge head that discharges a magenta paint, a Y color liquid discharge head that discharges a yellow paint, and a K color liquid discharge head that discharges a black paint are held. A W color liquid discharge head that discharges a white paint may also be held. A liquid discharge head that discharges a clear (transparent) coating material may be held, and coating may be applied simultaneously with printing.

A first Z-direction driver 140a that moves the carriage 110 in the Z direction (the liquid discharge direction and a contact/separation direction with respect to the liquid discharge target 200) along the Z-axis rail 103 is provided. A Y-direction driver 150 that moves the Z-axis rail 103 in the Y direction (a direction orthogonal to both the liquid discharge direction of the liquid discharge head and the nozzle arrangement direction, and the horizontal direction) along the Y-axis rail 101 is provided. An X-direction driver 160 that moves the Y-axis rail 101 in the X direction (the nozzle arrangement direction of the liquid discharge head and the vertical direction) along the X-axis rail 102 is provided. The Y-axis rail 101 is supported by the X-direction driver 160 held by each Y-axis rail 101. A second Z-direction driver 140b that moves the head holder 130 in the Z direction with respect to the carriage 110 is provided.

The X-direction driver 160 and the Y-direction driver 150 form a scanner to scan the carriage 110 that mounts the liquid discharge head in the X-axis direction and the Y-axis direction.

The liquid discharge apparatus 100 discharges paint, which is an example of liquid, from the liquid discharge head provided on the head holder 130 while moving the carriage 110 in the X-axis, Y-axis, and Z-axis directions, and performs drawing on the liquid discharge target 200. The movement of the carriage 110 and the head holder 130 in the Z direction is not necessarily parallel to the Z direction, and may be oblique movement as long as the movement includes at least a component in the Z direction. In a case where the number of nozzle rows of the liquid discharge head is one, it is possible to hold by the carriage 110 so as to be inclinable with respect to the X direction of the liquid discharge head, and a nozzle pitch may be made variable.

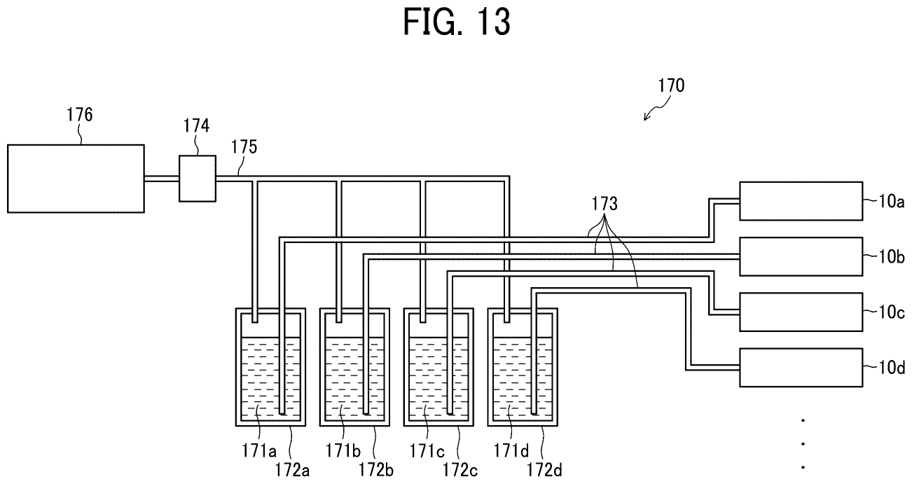

FIG. 13 is a diagram illustrating an example of a supply apparatus 170 that supplies paint as liquid to a plurality of liquid discharge heads 10 provided in the liquid discharge apparatus 100.

The supply apparatus 170 is provided with tanks 172a to 172d as sealed containers storing paints 171a to 171d discharged from liquid discharge heads 10a to 10d held by the head holder 130, respectively.

The tank 172 and the supply port 16 (refer to FIGS. 1A and 1B) of the liquid discharge head 10 are connected to each other via a tube 173. In contrast, the tank 172 is connected to a compressor 176 via a pipe 175 including an air regulator 174. The compressor 176 supplies pressurized air to the tank 172. As a result, the paint in the liquid discharge head 10 is in a pressurized state, and when the needle valve 8 as described above is opened, the paint is discharged from the nozzle 14.

Although a surface shape of the liquid discharge target 200 is illustrated as a plane in FIG. 13, the surface shape of the liquid discharge target 200 may be a surface close to vertical, such as a vehicle body of a vehicle or a truck, or a body of an aircraft, or a surface having a large curvature radius.

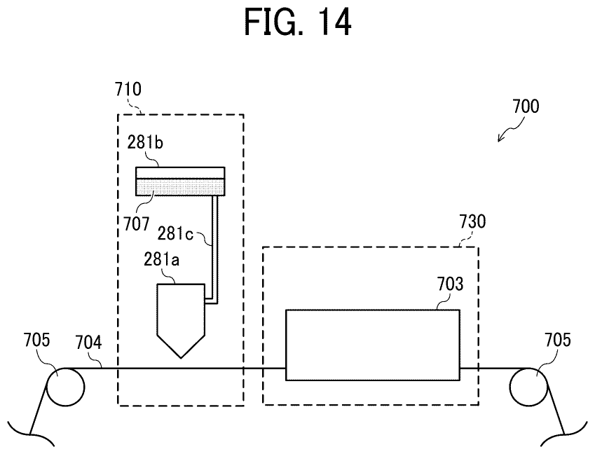

FIG. 14 is a diagram illustrating an example of an electrode manufacturing apparatus 700 as a liquid discharge apparatus provided with the liquid discharge head according to the present embodiment.

The electrode manufacturing apparatus 700 includes a discharge process unit 710 and a heating process unit 730. The discharge process unit 710 performs a process of applying a liquid composition onto a printing base material 704 including a discharge target to form a liquid composition layer. The heating process unit 730 performs a heating process of heating the liquid composition layer to obtain an electrode mixture layer.

The printing base material 704 on which the liquid composition layer is formed is not particularly limited as long as this is a target on which a layer including an electrode material is formed, and can be appropriately selected according to an object. For example, there is an electrode substrate (current collector), an active material layer, and a layer including a solid electrode material.

The discharge process unit 710 may directly discharge the liquid composition to form the layer including the electrode material as long as this can form the layer including the electrode material on the printing base material 704. It is possible to indirectly discharge the liquid composition to form the layer including the electrode material.

The heating process unit 730 is a process of heating the liquid composition discharged onto the printing base material 704 in the discharge process unit 710. The liquid composition layer can be dried by heating.

The electrode manufacturing apparatus 700 is provided with a conveyance unit 705 that conveys the printing base material 704, and the conveyance unit 705 conveys the printing base material 704 at a preset speed in an order of the discharge process unit 710 and the heating process unit 730. A method for manufacturing the printing base material 704 including the discharge target such as an active material layer is not particularly limited, and a known method can be appropriately selected. The discharge process unit 710 is provided with a printing apparatus 281a provided with the liquid discharge head 10 of the present embodiment that discharges the liquid composition onto the printing base material 704. A storage container 281b that stores the liquid composition, and a supply tube 281c that supplies the liquid composition stored in the storage container 281b to the printing apparatus 281a are provided.

The storage container 281b stores a liquid composition 707, and the discharge process unit 710 discharges the liquid composition 707 from the printing apparatus 281a to apply the liquid composition 707 onto the printing base material 704 to form a liquid composition layer in a thin film shape. The storage container 281b may be integrated with the manufacturing apparatus for the electrode mixture layer, or may be detachable from the manufacturing apparatus for the electrode mixture layer. The container may be used to be added to a storage container integrated with the manufacturing apparatus for the electrode mixture layer or a storage container detachable from the manufacturing apparatus for the electrode mixture layer.

The storage container 281b and the supply tube 281c can be optionally selected as long as the liquid composition 707 can be stably stored and supplied.

The heating process unit 730 includes a heater 703, and includes a solvent removal process of heating and drying a solvent remaining in the liquid composition layer by the heater 703 to remove. Thus, the electrode mixture layer can be formed. The heating process unit 730 may perform a solvent removal process under reduced pressure.

The heater 703 is not particularly limited, and can be appropriately selected according to a purpose, and examples thereof include a substrate heater, an IR heater, and a warm air heater, and they may be combined. Heating temperature and time can be appropriately selected according to a boiling point of the solvent included in the liquid composition 707 and a film thickness to be formed.

When the liquid discharge head 10 of the present embodiment is used as the electrode manufacturing apparatus 700, the liquid composition can be discharged to a target place of the discharge target. The electrode mixture layer can be suitably used as, for example, a part of the configuration of an electrochemical element. The configuration other than the electrode mixture layer in the electrochemical element is not particularly limited, and a known configuration can be appropriately selected, and examples thereof include a positive electrode, a negative electrode, and a separator, for example.

Although the present embodiment has been described above, the present embodiment is not limited to the above-described embodiment, and various changes can be made without departing from the gist of the present embodiment.

In the above description, an example in which a voltage is applied to a drive body such as the piezoelectric element 32 to open and close the needle valve 31 has been described. However, the present embodiment is not limited thereto, and the needle valve 31 may be opened and closed by pneumatic pressure or hydraulic pressure. In this case, a drive pulse generated by the drive controller is a drive waveform for driving a pressurizing mechanism by pneumatic pressure or hydraulic pressure at a set pressure.

A liquid discharge head includes: a nozzle plate having a nozzle from which a liquid is dischargeable in a discharge direction; a valve movable in the discharge direction to open and close the nozzle; a mover to move the valve in the discharge direction between: an open position at which the valve opens the nozzle; and a closed position at which the valve closes the nozzle; a housing to house the valve and the mover, the housing including: a first housing; a second housing coupled to the first housing at a coupling portion between the first housing and the second housing; and a groove on a periphery of the coupling portion of at least one of the first housing or the second housing; and a sealing in the groove to seal a portion between the housing and the valve, and the groove fixes a position of the sealing in the discharge direction.

In the liquid discharge head, the sealing has an elastic member, and the first housing and the second housing compress the sealing at a crushing ratio of 5 to 25%.

In the liquid discharge head, the sealing is a mold member, and the sealing has a parting line not in contact with the valve.

In the liquid discharge head, the sealing is a mold member, the sealing has: a parting line in contact with the valve or the housing with a first pressure; and a sealing portion in contact with the valve or the housing with a second pressure larger than the first pressure.

In the liquid discharge head, the sealing has an annular shape, the groove has an annular shape to hold the sealing, the first housing and the second housing compress the sealing in the groove at the coupling portion in the discharge direction, the sealing has an outer diameter in an uncompressed state in which the sealing is not compressed by the first housing and the second housing, and the groove has an inner diameter equal to or larger than the outer diameter of the sealing.

In the liquid discharge head, the sealing has an inner diameter in an uncompressed state in which the sealing is not compressed by the first housing and the second housing, the valve has a contact portion contacting with the sealing, and the contact portion of the valve has an outer diameter larger than the inner diameter of the sealing in the uncompressed state.

In the liquid discharge head, the first housing has a first face in the coupling portion, the second housing has a second face, facing the first face in the discharge direction, in the coupling portion, the first face of the first housing and the second face of the second housing forming a part of the groove, the first face and the second face compress the sealing in the groove at the coupling portion in the discharge direction, at least one of the first face or the second face has an inclination inclined relative to the discharge direction in a cross section parallel to the discharge direction.

In the liquid discharge head, the valve has a sliding portion slidable with the sealing, and at least one of a surface of the sealing or the sliding portion has a coating to reduce friction between the sliding portion and the sealing.

In the liquid discharge head, the valve has a sliding portion slidable with the sealing, and the sliding portion has an arithmetic average roughness Ra of 0.1 μm or less.

In the liquid discharge head, the first housing is closer to the nozzle plate than the second housing in the discharge direction, the first housing has a liquid chamber to store a liquid to be discharged from the nozzle, and the second housing includes a mover storage to store the mover.

A liquid discharge apparatus includes the liquid discharge head and a scanner to move the liquid discharge head.

In the present application, the “liquid discharge apparatus” is an apparatus provided with the liquid discharge head or the liquid discharge unit obtained by integrating functional parts and mechanisms with the liquid discharge head, the apparatus that drives the liquid discharge head to discharge the liquid. The integration includes a combination in which the liquid discharge head and the functional parts and mechanisms are secured to each other through fastening, bonding, and engaging, and a combination in which one is movably held by the other. The liquid discharge head may be detachably attached to the functional parts and mechanisms.

There also is the liquid discharge unit in which the liquid discharge head and the head tank are integrated and the liquid discharge unit in which the liquid discharge head and the head tank are connected to each other with a tube to be integrated. Here, a unit including a filter may be added between the liquid discharge head and the head tank of the liquid discharge unit.

Examples of the liquid discharge unit include the unit in which the liquid discharge head and a carriage are integrated, and the liquid discharge unit in which the liquid discharge head, the carriage, and the scan moving mechanism are integrated. Examples of the liquid discharge unit include the liquid discharge unit in which the liquid discharge head is movably held by a guide member that forms a part of the scan moving mechanism, and the liquid discharge head and the scan moving mechanism are integrated.

Examples of the liquid discharge unit include the liquid discharge unit in which a cap member as a part of a maintenance recovery mechanism is secured to the carriage to which the liquid discharge head is attached, and the liquid discharge head, the carriage, and the maintenance recovery mechanism are integrated. Examples of the liquid discharge unit include the liquid discharge unit in which a tube is connected to the liquid discharge head to which the head tank or flow path parts are attached, and the liquid discharge head and a supply mechanism are integrated. Liquid in a liquid reservoir source is supplied to the liquid discharge head through this tube.

The scan moving mechanism includes a guide member single body. The supply mechanism includes a tube single body and a loading unit single body.

The “liquid discharge apparatus” includes not only an apparatus that can discharge liquid to a material on which liquid can adhere but also an apparatus that discharges liquid toward gas or into liquid.

The “liquid discharge apparatus” may include a unit regarding feeding, conveyance, and ejection of a material on which liquid can adhere, a pretreatment apparatus, and a post-treatment apparatus.

The “liquid discharge apparatus” may be, for example, an image forming apparatus to form an image on a sheet by discharging ink, or a stereoscopic fabrication apparatus (three-dimensional fabrication apparatus) to discharge fabrication liquid to a powder layer in which powder material is formed in layers to fabricate a stereoscopic fabrication object (three-dimensional fabrication object).

The “liquid discharge apparatus” is not limited to an apparatus to discharge liquid to visualize meaningful images, such as letters or figures. For example, an apparatus to form meaningless images or fabricate three-dimensional images is also included.

The “material on which liquid can adhere” is the above-described liquid discharge target, and means a material to which the liquid can at least temporarily adhere and to which the liquid adheres and adheres, a medium to which the liquid adheres and permeates. Specific examples include recording media such as a sheet, recording paper, a recording sheet, a film, and a cloth, electronic components such as an electronic substrate and a piezoelectric element, and media such as a powder layer, an organ model, and a testing cell, and include any material on which liquid can adhere, unless particularly limited.

Examples of the “material on which liquid can adhere” include any materials on which liquid can adhere even temporarily such as paper, thread, fiber, fabric, leather, metal, plastic, glass, wood, and ceramic.

The “liquid discharge apparatus” may be an apparatus in which the head unit and the material on which the liquid can adhere move relative to each other; however, the liquid discharge apparatus is not limited to this. Specific examples include a serial type apparatus that moves the head unit, and a line type apparatus that does not move the head unit.

Examples of the “liquid discharge apparatus” further include a treatment liquid applying apparatus to discharge treatment liquid to a sheet for applying the treatment liquid to a sheet surface to reform the sheet surface. There also is an injection granulation apparatus for injecting composition liquid in which raw materials are dispersed in a solution through a nozzle hole to granulate fine particles of the raw material.

Although preferred embodiments of the present embodiment have been described above, the present embodiment is not limited to such specific embodiments, and unless particularly limited in the above description, various modifications and changes can be made without departing from the scope of the gist of the present embodiment recited in claims.

According to the present embodiment, it is possible to suppress variations in the amount and speed of droplets discharged from the nozzle.

The above-described embodiments are limited examples, and the present disclosure includes, for example, the following aspects having advantageous effects.

### Aspect 1

According to Aspect 1, in a liquid discharge head 10 including a nozzle plate 15 on which a nozzle 14 is formed, a valve such as a needle valve 31 that opens and closes the nozzle 14, a mover such as a piezoelectric element 32 that moves the valve between an open position at which the nozzle 14 is opened and a closed position at which the nozzle is closed, a housing such as a housing 11 including a liquid chamber 17 that stores liquid to be discharged from the nozzle 14 and a mover storage such as a piezoelectric element storage unit 330 that stores the mover, and a sealing 34 that abuts the housing and the valve and seals between the liquid chamber 17 and the mover storage, the sealing 34 is held by the housing so as not to be movable in a moving direction of the valve.

In Japanese Patent No. 7310404, the length in the moving direction of the valve of the holding groove provided on the valve is longer than the length of the sealing in the moving direction, and the sealing is movable in the holding groove within a predetermined range in the moving direction. Therefore, the sealing is slidable with respect to both the outer peripheral surface of the valve and the inner wall surface of the housing. Therefore, when the valve opens and closes, the sealing moves together with the valve and slides on the inner wall surface of the housing, or only the valve moves and the sealing slides on the valve, so that a target on which the sealing slides might change. As a result, the movement resistance during opening/closing of the valve varies, the movement amount and the moving speed of the valve vary, and the amount and speed of droplets discharged from the nozzle might vary.

In contrast, in Aspect 1, since the sealing is held in the housing so as not to be movable in the moving direction of the valve, the sealing slides only on the outer peripheral surface of the valve when the valve opens and closes. As a result, it is possible to suppress the variation of the movement resistance during opening/closing of the valve, and it is possible to suppress the variation in the movement amount and moving speed of the valve. As a result, it is possible to suppress variations in the amount and speed of droplets discharged from the nozzle.

### Aspect 2

According to Aspect 2, in the liquid discharge head 10 of Aspect 1, the sealing 34 is an elastic member, and is held by the housing such as the housing 11 at a crushing ratio of 5 to 25%.

According to this, as described in the embodiment, the sealing can be satisfactorily performed, and the permanent distortion of the sealing 34 can be suppressed.

### Aspect 3

According to Aspect 3, in the liquid discharge head 10 of Aspect 1 or 2, the sealing 34 is a mold member, and a parting line 34a of the sealing 34 is not in contact with the valve such as the needle valve 31 and the housing such as the housing 11, or an abutting pressure of the parting line 34a with the valve or the housing is lower than an abutting pressure of a sealing portion of the sealing 34 with the valve and a sealing portion with the housing.

According to this, as described with reference to FIGS. 8A and 8B, the parting line 34a of the sealing 34 can suppress generation of a low abutting pressure at the sealing portion with a counter member, and local liquid leakage can be suppressed.

### Aspect 4

According to Aspect 4, in the liquid discharge head 10 of any one of Aspects 1 to 3, the sealing 34 has an annular shape, the housing such as the housing 11 includes an annular holding groove 44 that holds the sealing 34, the sealing 34 is crushed in the moving direction (Z direction) by a pair of side surfaces of the holding groove 44, and an inner diameter d of a bottom surface of the holding groove 44 is equal to or larger than an outer diameter of the sealing 34 in an uncompressed state.

According to this, as described in the embodiment, the sealing 34 can be assembled to the holding groove 44 without reducing the diameter, and the sealing 34 can be easily assembled to the holding groove 44. The sealing 34 is compressed in the moving direction (Z direction) by the side surface of the holding groove 44, so that the sealing 34 abuts the side surface of the holding groove 44 at a predetermined abutting pressure, and it is possible to satisfactorily seal between the housing and the same.

### Aspect 5

According to Aspect 5, in the liquid discharge head 10 of Aspect 4, an outer diameter D of a contact portion of the valve such as the needle valve 31 with the sealing 34 is shorter than an inner diameter of the sealing in the uncompressed state.

According to this, as described in the embodiment, the valve such as the needle valve 31 can be easily inserted into the sealing 34, and the valve and the sealing can be easily assembled. The sealing 34 is compressed in the moving direction (Z direction) by the side surface of the holding groove 44 and crushed in a direction in which the inner diameter of the sealing is shortened, so that the sealing 34 can contact the valve to seal between the valve and the same.

### Aspect 6

According to Aspect 6, in the liquid discharge head 10 of any one of Aspects 1 to 5, the housing such as the housing 11 includes a holding groove that holds the sealing 34, the sealing 34 is compressed in the moving direction by a pair of side surfaces of the holding groove, and at least one side surface of the pair of side surfaces of the holding groove is inclined in the moving direction in a cross section parallel to the moving direction.

According to this, the sealing 34 is crushed to the valve side such as the needle valve by the compression by the side surface of the holding groove, and the abutting pressure with the valve can be increased, and the sealing can be satisfactorily performed.

### Aspect 7

According to Aspect 7, in the liquid discharge head 10 of any one of Aspects 1 to 6, at least one of a surface of the sealing 34 or a sliding portion of the valve such as the needle valve 31 with the sealing 34 is coated with a low friction material.

According to this, it is possible to reduce the sliding resistance with the sealing when the valve such as the needle valve moves.

### Aspect 8

According to Aspect 8, in the liquid discharge head 10 of any one of Aspects 1 to 7, arithmetic average roughness Ra of a sliding portion of the valve such as the needle valve with the sealing of the housing is 0.1 μm or less.

According to this, the sliding resistance between the sealing and the valve can be reduced when the valve such as the needle valve moves.

### Aspect 9

According to Aspect 9, in the liquid discharge head 10 of any one of Aspects 1 to 8, the sealing 34 is interposed and held in a moving direction (Z direction) by two members (first housing 11a and second housing 11b) forming the housing such as the housing 11.

According to this, sealing between the two members of the housing can also be performed by the sealing 34. After the sealing 34 is assembled to the cutout formed in any one of the two members forming the housing, the other member is assembled to the one member, and the sealing 34 can be compressed in the Z direction in the holding groove 44. As a result, it is not necessary to push the sealing 34 into the holding groove 44 to assemble to the holding groove 44, and the sealing 34 can be easily assembled.

### Aspect 10

According to Aspect 10, a liquid discharge apparatus including a liquid discharge head uses the liquid discharge head of any one of Aspects 1 to 9 as the liquid discharge head.

According to this, stable liquid discharge can be performed.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid discharge head comprising:
a nozzle plate having a nozzle from which a liquid is dischargeable in a discharge direction;
a valve movable in the discharge direction to open and close the nozzle;
a mover to move the valve in the discharge direction between:
an open position at which the valve opens the nozzle; and
a closed position at which the valve closes the nozzle;
a housing to house the valve and the mover, the housing including:
a first housing;
a second housing coupled to the first housing at a coupling portion between the first housing and the second housing; and
a groove on a periphery of the coupling portion of at least one of the first housing or the second housing; and
a sealing in the groove to seal a portion between the housing and the valve,
wherein the groove fixes a position of the sealing in the discharge direction.

2. The liquid discharge head according to claim 1,
wherein the sealing has an elastic member, and
the first housing and the second housing compress the sealing at a crushing ratio of 5 to 25%.

3. The liquid discharge head according to claim 1,
wherein the sealing is a mold member, and
the sealing has a parting line not in contact with the valve.

4. The liquid discharge head according to claim 1,
wherein the sealing is a mold member,
the sealing has:
a parting line in contact with the valve or the housing with a first pressure; and
a sealing portion in contact with the valve or the housing with a second pressure larger than the first pressure.

5. The liquid discharge head according to claim 1,
wherein the sealing has an annular shape,
the groove has an annular shape to hold the sealing,
the first housing and the second housing compress the sealing in the groove at the coupling portion in the discharge direction,
the sealing has an outer diameter in an uncompressed state in which the sealing is not compressed by the first housing and the second housing, and
the groove has an inner diameter equal to or larger than the outer diameter of the sealing.

6. The liquid discharge head according to claim 5,
wherein the sealing has an inner diameter in an uncompressed state in which the sealing is not compressed by the first housing and the second housing,
the valve has a contact portion contacting with the sealing, and
the contact portion of the valve has an outer diameter larger than the inner diameter of the sealing in the uncompressed state.

7. The liquid discharge head according to claim 1,
wherein the first housing has a first face in the coupling portion,
the second housing has a second face, facing the first face in the discharge direction, in the coupling portion,
the first face of the first housing and the second face of the second housing forming a part of the groove,
the first face and the second face compress the sealing in the groove at the coupling portion in the discharge direction,
at least one of the first face or the second face has an inclination inclined relative to the discharge direction in a cross section parallel to the discharge direction.

8. The liquid discharge head according to claim 1,
wherein the valve has a sliding portion slidable with the sealing, and
at least one of a surface of the sealing or the sliding portion has a coating to reduce friction between the sliding portion and the sealing.

9. The liquid discharge head according to claim 1,
wherein the valve has a sliding portion slidable with the sealing, and
the sliding portion has an arithmetic average roughness Ra of 0.1 μm or less.

10. The liquid discharge head according to claim 1,
wherein the first housing is closer to the nozzle plate than the second housing in the discharge direction,
the first housing has a liquid chamber to store a liquid to be discharged from the nozzle, and
the second housing includes a mover storage to store the mover.

11. A liquid discharge apparatus comprising:
the liquid discharge head according to claim 1; and
a scanner to move the liquid discharge head.
